(19) United States
(12) Patent Application Publication
(10) Pub. No.: US 2008/0016750 A1
(43) Pub. Date: Jan. 24, 2008

(54) Collapsible fishing rod holder

(76) Inventor: Donald Benton, North Bonneville, WA (US)

Correspondence Address: K.M. RYLANDER;RYLANDER & ASSOCIATES, 406 West 12th Street, Vancouver, WA, 98660, US

(21) Appl. No.: 11/491,246

(22) Filed: Jul. 21, 2006

(51) Int. Cl. A01K 97/10

(52) U.S. Cl. 43/21.2

(57) ABSTRACT

A collapsible fishing rod holder is provided and includes at least one base jointed member, a branch ready jointed member removably joinable to at least one base jointed member and having a first branch joint, a first branch member removably joinable to said first branch joint, and a second branch member at an acute angle in relation to the first branch member. In another embodiment, second branch member is removably joinable to said second branch joint. In another embodiment, base jointed members, branch ready jointed member, and at least one branch member, are hollow, and a tensioned line runs into and through each said member. In another embodiment, member connecting sleeves on the branch ready joint member and base jointed members, connect the branch ready jointed member to a base jointed member and base jointed members to another base jointed member. In another embodiment, a member connecting sleeve on the second branch member connects the second branch member to the branch ready jointed member. In another embodiment, a base member end tip is located on the end of the final base jointed member, allowing the holder to be placed into the ground or a stand.

### FIELD OF THE INVENTION

The present invention relates to fishing rod holders. More particularly, the present invention relates to fishing rods holders which can be taken apart.

### BACKGROUND

Fishing is a popular sport. Many people keep fishing rods in their cars in readiness to drop a line into an inviting stream. Waiting for the fish to strike requires patience. Fishing rod holders have been created to allow people to have their line in the water, but keep their hands free, with the fishing rod resting on the holder, usually angled up. Fishing rod holders are typically larger than a fishing tool kit and can be bulky or unwieldy. A fishing rod holder which can completely collapse into straight, short segments with no unwieldy protuberances, so that it can be easily put in and carried in a fishing tool kit, is a desired advance not seen in the existing art.

The following represents a list of known related art:

| Reference: | Issued to: | Date of Issue: |
|---|---|---|
| U.S. Pat. No. 6,678,989 | Lowe | Jan. 20, 2004 |
| U.S. Pat. No. 3,858,833 | Fink | Jan. 7, 1975 |
| U.S. Pat. No. 3,245,169 | Kennel | Apr. 12, 1966 |
| U.S. Pat. No. 4,700,502 | McFarland | Oct. 20, 1987 |
| U.S. Pat. No. 4,642,931 | Flores | Feb. 17, 1987 |
| U.S. Pat. No. 4,052,808 | Crabtree | Oct. 11, 1977 |
| U.S. Pat. No. 3,947,141 | Casset | Mar. 30, 1972 |
| U.S. Pat. No. 2,833,500 | Jones | May 6, 1958 |
| U.S. Pat. No. 2,900,153 | Lazur | Aug. 18, 1959 |

The teachings of each of the above-listed citations (which does not itself incorporate essential material by reference) are herein incorporated by reference. None of the above inventions and patents, taken either singularly or in combination, is seen to describe the instant invention as claimed.

U.S. Pat. No. 6,678,989 to Lowe, teaches a fishing spear, which includes a number of hollow cylinders joined by coupling tubes and a pair of washers inside the cylinders through which an elastic cord is attached. Additionally, one end of the series of connected cylinders is pointed to form a spear. The invention of this patent lacks a forked end on which to secure a fishing pole.

U.S. Pat. No. 3,858,833, to Fink, teaches a holder with a “y-shaped” end to hold a fishing rod and a pointed opposite end to secure the holder into the ground. The holder is made of segments of telescoping tubular body members secured to each other by angular grooves and o-rings. The invention of this patent collapses by disengaging the angular grooves and o-rings, thereby allowing the segments of the holder to telescope into each other.

U.S. Pat. No. 3,245,169, to Kennel, teaches a series of solid rod sections connected with ferrules and external springs.

U.S. Pat. No. 4,700,502 to McFarland, teaches a fishing gear container to facilitate transport having tubular segments that can be threaded together, a sling for ease of transport, a pole holder segment in which the pole handle can be secured, the pole holder segment can then be attached to all segments for transport or to a stake assembly which can be secured in the ground.

U.S. Pat. No. 4,642,931, to Flores, teaches a series of pivotally connected rods with a slip cover at each pivot point to secure the connected segments; one end of the rod is pointed so as to be placed into the ground or the same end may be connected to a holder. The other end of the series of connected rods includes a “V-shaped” spring, which is retractable from the end rod and can be secured in place by a pin. A fishing pole can then rest in the spring's nook. The invention of this patent utilizes external link joints to connect the segments, lacks an internal elastic cord, and has a retractable, forked end upon which to rest a fishing pole.

U.S. Pat. No. 4,052,808, to Crabtree, teaches a fishing spear with telescoping hollow rod segments in which is located an elastic band allowing the rod to collapse; at one end of the rod is a spear and at the other end is an elastic loop for propelling the spear. Similar to the Lowe patent, the invention of this patent lacks a forked end on which to secure a fishing pole.

U.S. Pat. No. 3,947,141, to Casset, teaches a segmented fishing rod, in which segments are connectable via tapered ends which fit inside the subsequent segment; an elastic cord between segments secures the segments together.

U.S. Pat. No. 2,833,500, to Jones, teaches a fishing rod support including a pair of segments connected via a tubular sleeve and secured with a pin; one of the segments further includes a reel mount with a handle and a chuck opposite the mount, in which the fishing rod is secured to the chuck and the fishing reel rests in the reel mount, and the other segment has a pair of “L-shaped” prongs to secure the support into the ground or onto a base. The invention of this patent utilizes only two segments secured by a pin.

U.S. Pat. No. 2,900,153, to Lazur, teaches a fishing rod support. The fishing rod support includes a hollow standard pole with a pointed end and an extending rod fitting inside the hollow standard pole. The extending rod can be adjusted to varying heights and locked in place when extended. One end of the extending rod is forked to secure a fishing pole while the fishing pole handle is held in place via a cable connected to the hollow standard pole. The invention of this patent utilizes two poles, one inside the other, to adjust the height of the support.

Still other features would be desirable in a fishing pole support. For example, complete collapsibility, a forked end, and tensioned lines to ease reassembly. Thus, while the foregoing body of art indicates it to be well known to have a fishing rod support, the art described above does not teach or suggest a collapsible fishing rod holder which has the following combination of desirable features: (1) collapsibility, (2) forked or “Y”-shaped end, (3) tensioned lines and (4) collapsibility of the forked end.

### SUMMARY AND ADVANTAGES

A collapsible fishing rod holder is provided and includes at least one base jointed member, a branch ready jointed member removably joinable to at least one base jointed member and having first and second branch joints at an acute angle in relation to each other, a first branch member removably joinable to said first branch joint, and a second branch member at said second branch joint. Second branch member can be removably joinable to said second branch joint. A member connecting sleeve can be provided on the second branch member to removably connect the second branch member to the branch ready jointed member. Base jointed members, branch ready jointed member, and branch members can be hollow with a tensioned line running into and through each said member.

The collapsible fishing rod holder of the present invention presents numerous advantages, including ease of portability, ease in assembly, durability, general collapsibility, a forked or “Y”-shaped end, tensioned lines, and collapsibility of the forked end. Additional advantages of the invention will be set forth in part in the description which follows, and in part will be obvious from the description, or may be learned by practice of the invention. The advantages of the invention may be realized and attained by means of the instrumentalities and combinations particularly pointed out in the appended claims. Further benefits and advantages of the embodiments of the invention will become apparent from consideration of the following detailed description given with reference to the accompanying drawings, which specify and show preferred embodiments of the present invention.

### BRIEF DESCRIPTION OF THE DRAWINGS

The accompanying drawings, which are incorporated into and constitute a part of this specification, illustrate one or more embodiments of the present invention and, together with the detailed description, serve to explain the principles and implementations of the invention.

FIG. 1 shows a side view of an embodiment of a collapsible fishing rod holder.

FIG. 2 shows a side view of an embodiment of a collapsed, collapsible fishing rod holder.

FIG. 3 shows a side view of another embodiment of a collapsible fishing rod holder.

### DETAILED DESCRIPTION

Before beginning a detailed description of the subject invention, mention of the following is in order. When appropriate, like reference materials and characters are used to designate identical, corresponding, or similar components in differing figure drawings. The figure drawings associated with this disclosure typically are not drawn with dimensional accuracy to scale, i.e., such drawings have been drafted with a focus on clarity of viewing and understanding rather than dimensional accuracy.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

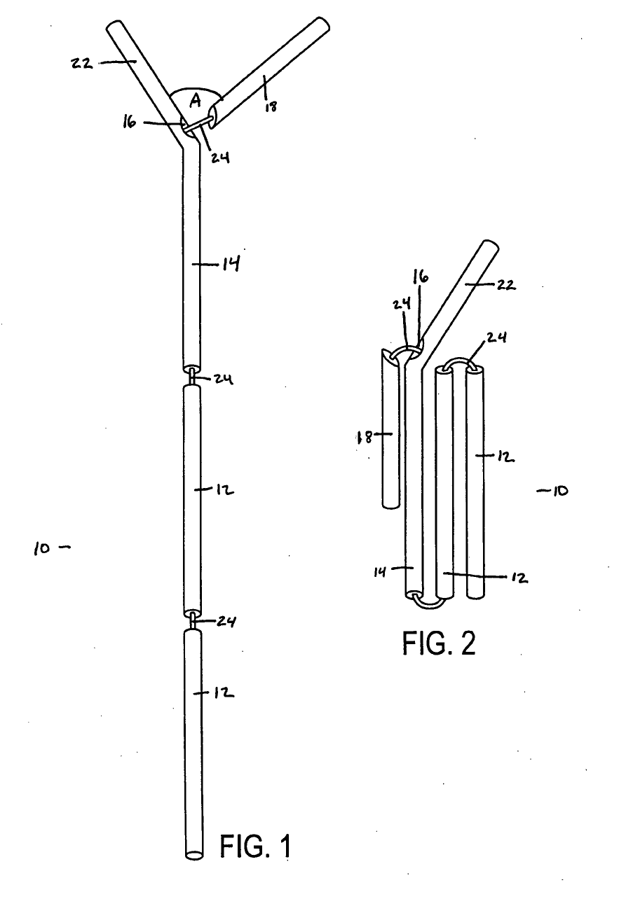

As shown in FIGS. 1-3, a collapsible fishing rod holder 10 is provided. Holder 10 is a “Y” shaped segmented apparatus which can be broken down by segments, including the segments forming the branch of the “Y”, to allow for easy transport, such as in a tackle box or in a pouch. In the preferred embodiment, segments are connected by an elastic cord, which allow the holder segments to be folded together, and then easily reconnected assisted by the tension of the elastic cord.

As shown in FIG. 1, holder 10 includes at least one base jointed member 12, a branch ready jointed member 14 removably joinable to at least one base jointed member 12 and having a first branch joint 16, a first branch member 18 removably joinable to the first branch joint 16, and a second branch member 22 wherein the first and second branch members 18, 22 form an acute angle A in relation to each other.

As shown in FIGS. 1, 2, and 3, base jointed members 12, branch ready jointed member 14, and the first branch member 18, can be hollow, with a tensioned line 24 that runs into and through each said member 12, 14, 18, 22.

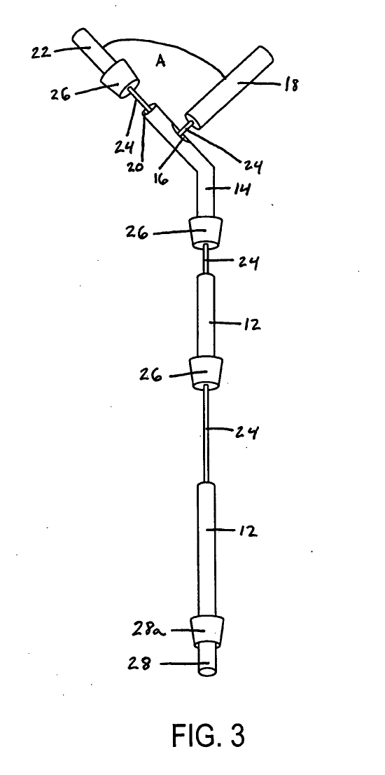

Base jointed members 12 are preferably elongated rods hollow at each tip to make a joint. Branch jointed member 14 can be a rod bent at an obtuse angle at its midpoint to form the second branch member 22, and having a joint 16 at the bend into which a first branch member 18 can be partially inserted, as shown in FIG. 1. As shown in FIG. 3, branch jointed member 14 can also be provided with a second joint, 20. In this embodiment, second branch member 22 is a rod removably connectable to second joint 20. First and second branch members 18, 22 are preferably elongated rods. When first branch member 18 is inserted into joint 16 of branch jointed member 14, it forms a “Y” with second branch member 22 with acute angle A between the tips.

In the preferred embodiment, the tensioned line 24 is elastic such that when the base jointed members 12, are not folded the tension from the line 24 causes the base jointed members 12 to secure themselves to one another, creating a pole. Numerous methods are known to those skilled in the art for removably connecting members to form a pole. Alternatively, the tensioned line 24 is a taut cord or string. The tensioned line 24 can be attached to the ends of the base jointed members 12 or the branch ready jointed member 14, or, if such members are hollow, the tensioned line 24 can run through the members 12, 14. Those with ordinary skill in the art will realize that tensioned lines 24 can be attached to the members 12, 14 via numerous methods, including adhesives, staples, clips, or built into the members 12, 14.

As shown in FIGS. 1 and 2, the first branch member 18 is preferably angled at its end so as to easily fit into the first branch joint 16 and preserve the acute angle A between the first and second branch members 18, 22 when assembled.

Each base jointed member 12 can be provided with a member connecting sleeve 26, as shown in FIG. 3, to secure each base jointed member 12 to another base jointed member 12. The branch ready jointed member 14 can also has a member connecting sleeve 26 to secure the branch ready jointed member 14 to a base jointed member 12. The member connecting sleeves 26 are secured to the end of the base jointed member 12 or the branch ready jointed member 14 farthest from the fork or “Y” formed by the first and second branch members 18, 22. The member connecting sleeves 26 slip over the ends of the base jointed member 12 or the branch ready jointed member 14. Member connecting sleeves 26 are preferably secured with an adhesive to the end of the base jointed member 12 or the branch ready jointed member 14 farthest from the fork or “Y.” The member connecting sleeves 26 can be pinched onto the end of the base jointed member 12 or the branch ready jointed member 14 farthest from the fork or “Y.” The non-secured end of the member connecting sleeve 26 is then removably attached to a base jointed member 12 by sliding the member connecting sleeve 26 over the base jointed member 12, thus assembling the holder 10 into an upright, rigid pole. Gravity ensures that when the holder 10 is in use, the member connecting sleeves 26 secure the base jointed members 12, thereby providing a rigid holder 10 when assembled.

Base jointed members 12, branch ready jointed member 14, and the first and second branch members 18, 22, are preferably constructed of a lightweight, rigid plastic to ensure the holder 10 can support a fishing pole but retains easy portability.

A base member end tip 28 can be provided to secure the holder 10 into the ground or a stand. The base member end tip 28 comprises a sleeve that fits over the holder 10 end opposite the branch ready joint member 14. The base member end tip 28 sleeve slips over the final base jointed member 12 as depicted in FIG. 3. Gravity ensures that when the holder 10 is in use, the base member end tip 28 secures the final base jointed member 12, thereby securing the entire holder 10 when the holder 10 is assembled. The base member end tip 28 is preferably also secured with an adhesive to the final base jointed member 12. The other end of the base member end tip 28, opposite the sleeve 28a, is narrower in diameter than the sleeve 28a. This part of the base member end tip 28, opposite the sleeve 28a, is preferably a flat edge. One of skill in the art would realize that the base member end tip 28 could be tapered.

In operation, the holder 10 segments are joined to form a rod with a “Y”-shaped top. The user can then separate the base jointed members 12 by pulling them apart and folding one base jointed member 12 adjacent to another, as depicted in FIG. 2. The user can then pull the first branch member 18 out of the first branch joint 16, thereby allowing the user to fold the first branch member 18 adjacent to the branch ready jointed member 14. The result is the holder 10 is folded up for transport or storage as shown in FIG. 2. To reassemble the holder 10, the user unfolds the base jointed members 12 which fit end to end, either by their hollow tipped joints, tensioned lines 24 (FIGS. 1-3), and/or member connecting sleeves 26 (FIG. 3). The user then unfolds the first branch member 18, which preferably snaps into the first branch joint 16. The holder 10 can then be pushed into the ground or into a stand and a fishing rod placed in the fork or “Y” formed by the first and second branch members 18, 22. Where members are connected by a tensioned line 24, the tension helps the user snap the members into place in the joints. The tensioned line 24 also keeps the members closer together when disassembled.

In another embodiment, as shown in FIG. 3, the user can also remove the second branch member 22 from the second branch joint 20 and fold the second branch member 22 adjacent to the branch ready jointed member 14. To reassemble, the user unfolds the second branch member 22, which preferably snaps into the second branch joint 20. Where members, including the second branch member 22, are connected by a tensioned line 24, the tension helps the user snap the members into place in the joints. The tensioned line 24 also keeps the members closer together when disassembled.

In another embodiment, the base jointed members 12 fit end to end via the member connecting sleeves 26 and the branch ready jointed member 14 is secured to the uppermost base jointed member 12 via a member connecting sleeve 26. In another embodiment, the removably attached second branch member 22 is secured to the branch ready jointed member 14 via a member connecting sleeve 26. The member connecting sleeve 26 of the second branch member 22 may be fixed to the base of the second branch member 22 and slide over a portion of the branch ready jointed member 14. When the holder 10 is assembled, gravity ensures that each member connecting sleeve 26 is securely fixed to either the base jointed member 12 or the branch ready jointed member 14 to which it is removably attached.

In yet another embodiment, the holder 10 can then be pushed into the ground or into a stand, where it is secured by a base member end tip 28.

Those skilled in the art will recognize that numerous modifications and changes may be made to the preferred embodiment without departing from the scope of the claimed invention. It will, of course, be understood that modifications of the invention, in its various aspects, will be apparent to those skilled in the art, some being apparent only after study, others being matters of routine mechanical, chemical and electronic design. No single feature, function or property of the preferred embodiment is essential. Other embodiments are possible, their specific designs depending upon the particular application. As such, the scope of the invention should not be limited by the particular embodiments herein described but should be defined only by the appended claims and equivalents thereof.

I claim:

1. A collapsible fishing rod holder, comprising:
at least one base jointed member;
a branch ready jointed member removably joinable to at least one base jointed member and having a first branch joint;
a first branch member removably joinable to said first branch joint; and
a second branch member, at an acute angle in relation to said first branch member.

2. The holder of claim 1, further comprising member connecting sleeves to secure each said base jointed member to another said base jointed member and to secure said branch ready jointed member to said base jointed member.

3. The holder of claim 1 or 2, further comprising a base member end tip to secure said holder into the ground or a stand.

4. The holder of claim 1 or 2, further comprising one or more tensioned lines connecting each said base jointed member, said branch ready jointed member, and said branch member, from each said member to the next.

5. A collapsible fishing rod holder, comprising:
at least one base jointed member;
a branch ready jointed member removably joinable to at least one base jointed member and having a first branch joint;
a first branch member removably joinable to said first branch joint; a second branch member, at an acute angle in relation to said first branch member;
one or more tensioned lines connecting each said base jointed member, said branch ready jointed member, and said branch member, from each said member to the next;
member connecting sleeves to secure each said base jointed member to another said base jointed member and to secure said branch ready jointed member to said base jointed member; and
a base member end tip to secure said holder into the ground or a stand.

6. A collapsible fishing rod holder, comprising:
at least one base jointed member;
a branch ready jointed member removably joinable to at least one base jointed member and having first and second branch joints;
a first branch member removably joinable to said first branch joint; and
a second branch member removably joinable to said second branch joint, at an acute angle in relation to said first branch member.

7. The holder of claim 6, further comprising one or more tensioned lines connect each said base jointed member, said branch ready jointed member, and said first and second branch members, from each said member to the next.

8. The holder of claim 6 or 7, further comprising member connecting sleeves to secure each said base jointed member to another said base jointed member, to secure said branch ready jointed member to said base jointed member, and to secure said second branch member to said branch ready jointed member.

9. The holder of claim 6 or 7, further comprising a base member end tip to secure said holder into the ground or a stand.

10. A collapsible fishing rod holder, comprising:
at least one base jointed member;
a branch ready jointed member removably joinable to at least one base jointed member and having first and second branch joints;
a first branch member removably joinable to said first branch joint; and
a second branch member removably joinable to said second branch joint, at an acute angle in relation to said first branch member;
one or more tensioned lines connect each said base jointed member, said branch ready jointed member, and said first and second branch members, from each said member to the next;
member connecting sleeves to secure each said base jointed member to another said base jointed member, to secure said branch ready jointed member to said base jointed member, and to secure said second branch member to said branch ready jointed member; and
a base member end tip to secure said holder into the ground or a stand.

11. A collapsible fishing rod holder, comprising:
at least one base jointed member wherein each said base jointed member is hollow;
a hollow branch ready jointed member removably joinable to at least one base jointed member and having first and second branch joints; hollow first and second branch members removably joinable to said first and second branch joints respectively, said first and second branch members at an acute angle in relation to each other;
an elastic line running from said first branch member, through said branch ready jointed member, and through each base jointed member; and
an elastic line running from said second branch member to said branch ready jointed member.

12. The holder of claim 11, further comprising member connecting sleeves to secure each said base jointed member to another said base jointed member, to secure said branch ready jointed member to said base jointed member, and to secure said second branch member to said branch ready jointed member.

13. The holder of claim 11 or 12, further comprising a base member end tip to secure said holder into the ground or a stand.

14. A collapsible fishing rod holder, comprising:
at least one base jointed member wherein each said base jointed member is hollow;
a hollow branch ready jointed member removably joinable to at least one base jointed member;
a hollow first branch member removably joinable to said hollow branch ready jointed member;
a second branch member, at an acute angle in relation to said first branch member; and
an elastic line running from said first branch member, through said branch ready jointed member, and through each base jointed member.

15. The holder of claim 14, further comprising member connecting sleeves to secure each said base jointed member to another said base jointed member and to secure said branch ready jointed member to said base jointed member.

16. The holder of claim 14 or 15, further comprising a base member end tip to secure said holder into the ground or a stand.
